(19) United States
(12) Patent Application Publication
(10) Pub. No.: US 2023/0415996 A1
(43) Pub. Date: Dec. 28, 2023

(54) WAREHOUSE WORK CONTROL SYSTEM AND WAREHOUSE WORK CONTROL METHOD

(71) Applicant: Hitachi, Ltd., Tokyo (JP)

(72) Inventors: Tomohiro MATSUDA, Tokyo (JP); Hideya YOSHIUCHI, Tokyo (JP)

(21) Appl. No.: 18/205,344

(22) Filed: Jun. 2, 2023

(30) Foreign Application Priority Data
Jun. 23, 2022 (JP) 2022-101456

(51) Int. Cl. B65G 1/137; G05D 1/02

(52) U.S. Cl. CPC B65G 1/1373; G05D 1/0287; G06Q 10/087; G06Q 10/063114; G05D 1/0217; G06Q 10/06316; G05D 2201/0216

(57) ABSTRACT

The disclosure is to eliminate a load on a portion as a bottleneck portion between work processes in a warehouse work control system. The invention includes: a work delay detection unit configured to detect a work delay of each of work subjects; a group configuration change unit configured to change a configuration of a work group when it is determined that the work delay is hindersome to execution of a work; a shift determination unit configured to determine a shift of the work subject when it is determined that the work subject whose work group is changed is present; and an on-movement-path work determination unit configured to determine the work to be performed on a movement path by the work subject.

### BACKGROUND OF THE INVENTION

### 1. Field of the Invention

The present invention relates to a warehouse work control system and a warehouse work control method.

### 2. Description of Related Art

Internet of Things (IoT) technology for connecting all devices to the Internet and providing various services is becoming widespread. During a rapid increase in the number of devices connected to the Internet, attention is paid to use of robots in various fields against a background of a progress of robot technology and a lack of labor associated with declining birthrate and a growing proportion of elderly people.

Various robots such as a robot that performs a shelf transport work, a conveyor that transports a package, and a picking robot that performs a picking work are introduced also in a distribution work in a distribution warehouse. The robots are mainly robots that each perform a single work, and an effort is made to automate works in warehouses by combining the robots.

Warehouse works are roughly divided into arrival works and shipment works, which are performed in different work regions depending on an arrival source, a shipment destination, a storage place, or the like. Therefore, it is considered to execute the warehouse works by setting robots and operators that perform a series of works necessary for arrival or shipment as one group and assigning the works to each of a plurality of groups.

PTL 1 discloses a work planning system including a processor and a storage unit connected to the processor. The storage unit stores a plurality of shipment orders, work network information related to a process of a work required for shipment, and resource information related to a plurality of resources available for the work. The processor classifies works corresponding to the plurality of shipment orders into a plurality of tasks based on a predetermined condition and the work network information, generates a process plan including assignment of the resource to the process for each of the tasks based on the resource information, and outputs the generated process plan.

### CITATION LIST

### Patent Literature

PTL 1: JP2021-33873A (Japanese Patent No. 6876108)

### SUMMARY OF THE INVENTION

By using the technique described in PTL 1, it is possible to average the works with respect to the groups that perform the series of works in the warehouse by equally distributing the works to the groups.

However, in the logistics industry, the number of arrivals and the number of shipment are largely changed due to external factors such as an event of sale, season, and the like, weather, and road condition. The work time in the groups also changes depending on work path, failure, skill level of worker, and the like. Therefore, it is necessary to change arrangement between groups in accordance with the work as a bottleneck portion or loads of the robots for each group.

In PTL 1, it is not considered to eliminate the load on a portion as the bottleneck portion between the work processes.

An object of the invention is to eliminate a load on a portion as a bottleneck portion between work processes in a warehouse work control system.

A warehouse work control system according to an aspect of the invention is a warehouse work control system including: a plurality of information processing devices configured to move autonomously and, in a warehouse having a plurality of work processes, each perform a work for each of the work processes; a processing time calculation unit configured to calculate a processing time of the work assigned to the work processes; a movement path calculation unit configured to calculate a movement path through which each of the information processing devices moves between the work processes; and a movement determination unit configured to determine, by using the processing time and the movement path, movement of the information processing device between the work processes based on an operation situation and a movement direction of the information processing device for each work process.

According to an aspect of the invention, it is possible to eliminate a load on a portion as a bottleneck portion between work processes in a warehouse work control system.

### BRIEF DESCRIPTION OF THE DRAWINGS

FIG. 1 is a diagram showing an example of a configuration of a warehouse work control system according to an embodiment;

FIG. 2 is a diagram showing an example of a configuration of an operation management server;

FIG. 3 is a flowchart showing an example of a warehouse work control program;

FIG. 4 is a flowchart showing an example of a work delay detection program;

FIG. 5 is a flowchart showing an example of a group configuration change program;

FIG. 6 is a flowchart showing an example of a shift determination program;

FIG. 7 is a flowchart showing an example of an on-movement-path work determination program;

FIG. 8 is a block diagram showing a structure of data managed by a group information database;

FIG. 9 is a block diagram showing a structure of data managed by a work result information database;

FIG. 10 is a block diagram showing a structure of data managed by an intra-group line information database;

FIG. 11 is a block diagram showing a structure of data managed by a buffer information database;

FIG. 12 is a block diagram showing a structure of data managed by an order information database;

FIG. 13 is a block diagram showing a structure of data managed by a worker information database;

FIG. 14 is an example of movement between work groups in a warehouse;

FIG. 15 is an example of utilization of a system including the warehouse work control system; and

FIG. 16 is an example of a warehouse work control screen.

### DESCRIPTION OF EMBODIMENTS

Hereinafter, an embodiment according to the invention will be described in detail with reference to the drawings.

The following embodiment is divided into a plurality of sections or embodiments and described when necessary for convenience of description. Unless otherwise specified, the sections or embodiments are not irrelative to each other, and one is a modification, details, or supplementary description of a part or all of the others.

In the following example, when referring to the number of elements and the like (including numbers, numerical values, amounts, ranges, and the like), the number is not limited to a specific number and may be more than or equal to, or less than or equal to the specific number unless otherwise specifically indicated or principally apparent that the number is limited to the specific number.

In the following example, it is needless to say that elements (including element steps and the like) are not essential unless otherwise specifically indicated or principally apparent that the elements are essential.

### EMBODIMENT

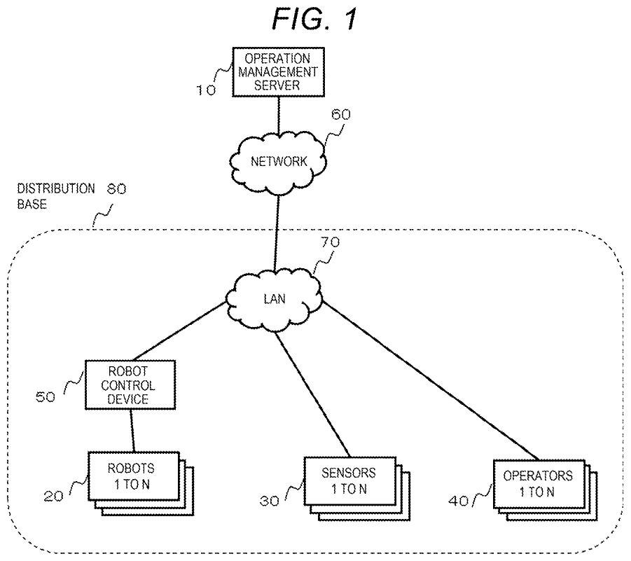

FIG. 1 is a diagram showing an example of a configuration of a warehouse work control system according to Embodiment 1. The warehouse work control system according to Embodiment 1 includes an operation management server 10 that performs operation management of the entire system, and a distribution base 80 provided with robots 20 that are autonomously movable information processing devices operating in a warehouse, sensors 30 that measure data in the warehouse, operators 40 who work in the warehouse, and a robot control device 50 that is a control device controlling the robots 20. Here, mobile equipment is described as the robots 20 that are autonomously movable information processing devices, and the mobile equipment is not limited to the robots 20 and also includes equipment that can move in a wide range, such as a drone or an automatic driving car.

The operation management server 10 and the distribution base 80 are connected by a network 60. The inside of the distribution base is connected by a local area network (LAN) 70. A connection method of the LAN is, for example, a wired LAN, a wireless LAN, or a short-range wireless connection, and a plurality of connection methods may be used in combination.

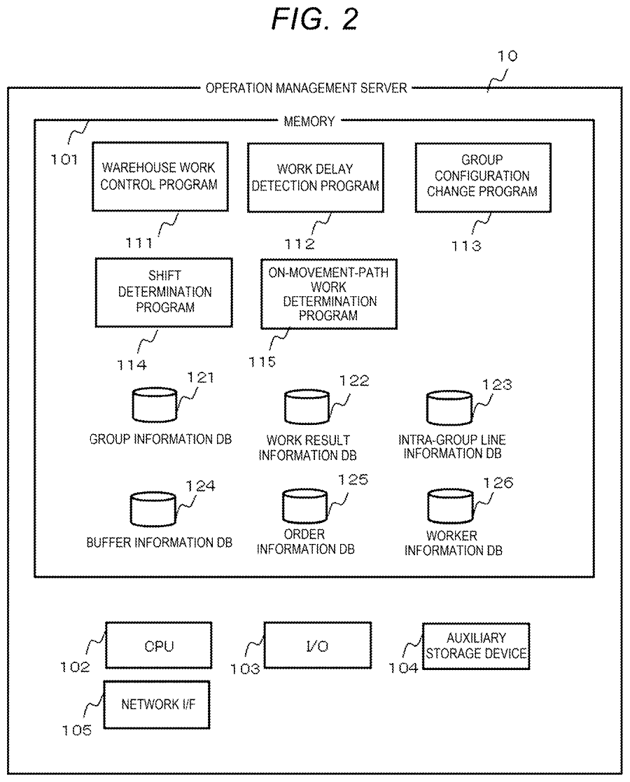

FIG. 2 is a diagram showing an example of a configuration of the operation management server 10. Processing content of the operation management server 10 is stored in an auxiliary storage device 104 of a general computer in a form of a program (software). A central processing unit (CPU) 102 loads the program read from the auxiliary storage device 104 in a memory 101 and executes the program. The operation management server communicates with other servers, service equipment, and robots via a network I/F 105.

An input and output interface (I/O) 103 is a user interface through which a user inputs an instruction to the operation management server 10 and an execution result of the program or the like is presented to the user. An input and output device (for example, a keyboard, a mouse, a touch panel, a display, a printer) is connected to the I/O 103. The I/O 103 may be connected to a user interface provided by a management terminal connected via a network.

The CPU 102 is a processor that executes a program stored in the memory 101. The memory 101 includes a read only memory (ROM) that is a nonvolatile storage element and a random-access memory (RAM) that is a volatile storage element. The ROM stores an unchanged program (for example, a basic input output system (BIOS)). The RAM is a high-speed and volatile storage element such as a dynamic random-access memory (DRAM), and temporarily stores a program stored in the auxiliary storage device 104 and data used when the program is executed.

Specifically, the memory 101 stores a warehouse work control program 111, a work delay detection program 112, a group configuration change program 113, a shift determination program 114, and an on-movement-path work determination program 115.

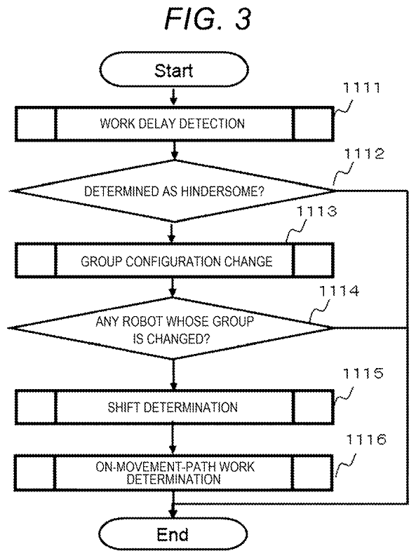

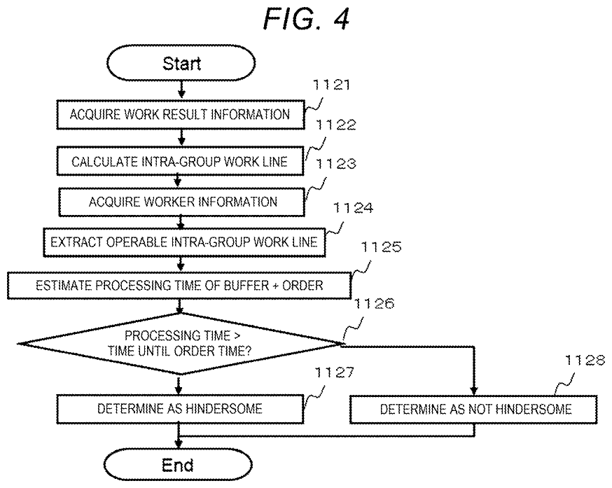

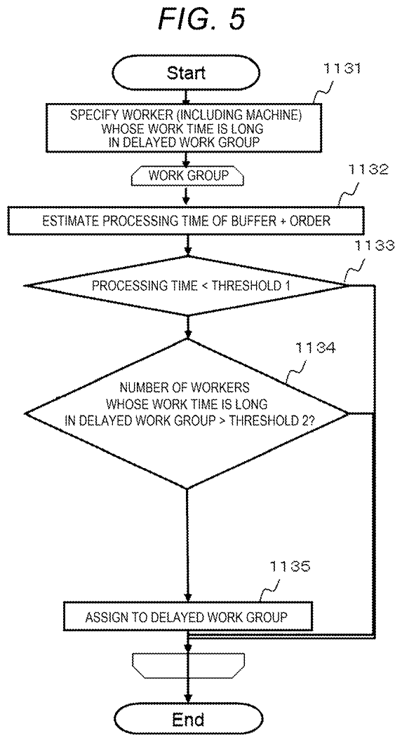

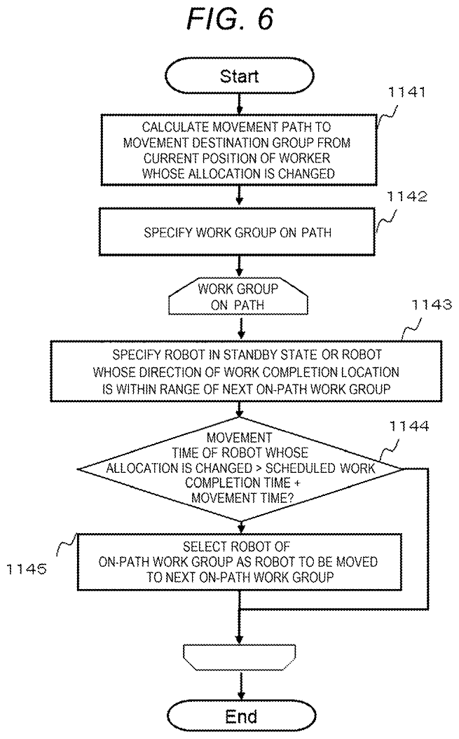

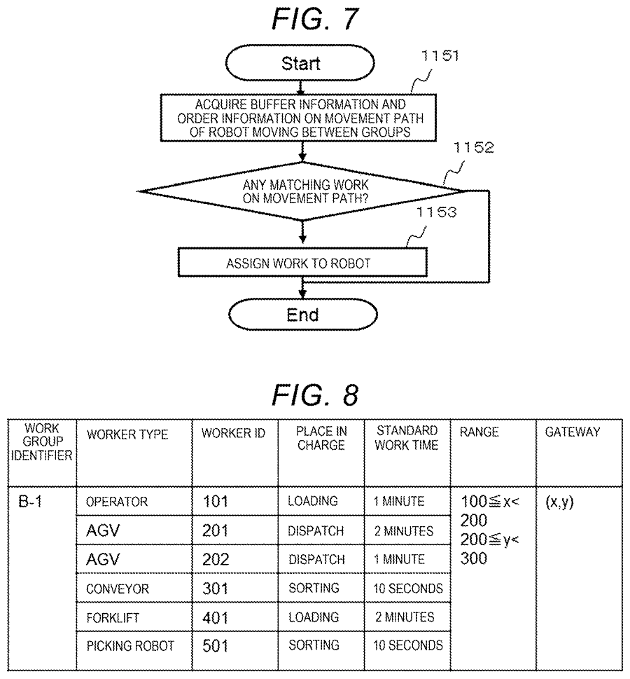

The warehouse work control program 111 is a program for executing warehouse work control (see FIG. 3). The work delay detection program 112 is a program for executing work delay detection (see FIG. 4). The group configuration change program 113 is a program for executing group configuration change (see FIG. 5). The shift determination program 114 is a program for executing shift determination (see FIG. 6). The on-movement-path work determination program 115 is a program for executing on-movement-path work determination (see FIG. 7).

The warehouse work control program 111, the work delay detection program 112, the group configuration change program 113, the shift determination program 114, and the on-movement-path work determination program 115 respectively constitute a warehouse work control unit, a work delay detection unit, a group configuration change unit, a shift determination unit, and an on-movement-path work determination unit by executing the programs by the CPU 102.

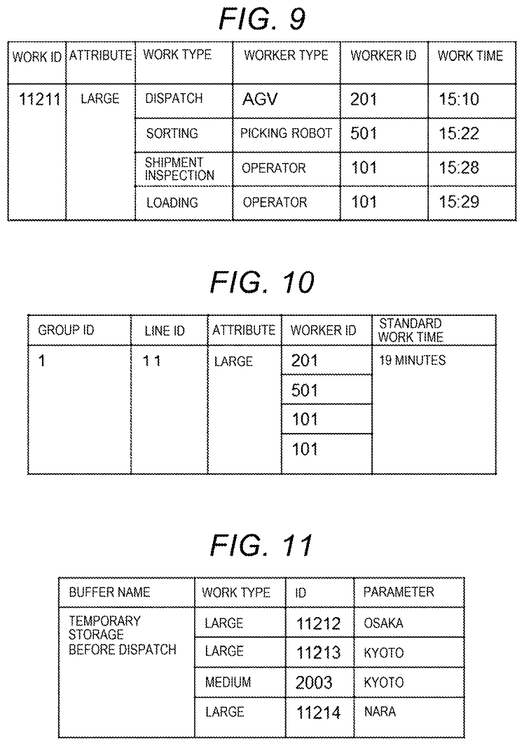

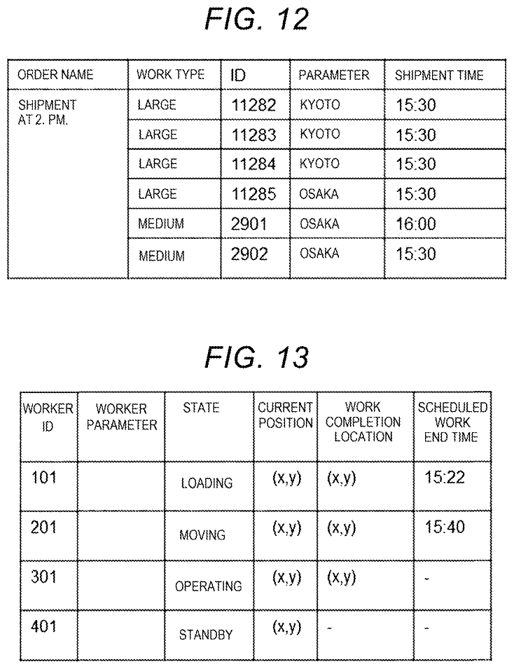

The memory 101 stores group information DB 121 (see FIG. 8), work result information DB 122 (see FIG. 9), intra-group line information DB 123 (see FIG. 10), buffer information DB 124 (see FIG. 11), order information DB 125 (see FIG. 12), and worker information DB 126 (see FIG. 13).

The auxiliary storage device 104 is, for example, a large-capacity and non-volatile storage device such as a magnetic storage device (a hard disk drive (HDD)) or a flash memory (a solid-state drive (SSD)). In addition, the auxiliary storage device 104 stores the program executed by the CPU 102 and the data used when the program is executed. That is, the program is read from the auxiliary storage device 104, loaded into the memory 101, and executed by the CPU 102.

The operation management server 10 is a computer system physically configured on one computer or configured on a plurality of logical or physical computers. The programs stored in the memory 101 may operate on a separate thread on the same computer, or may operate on a virtual computer constructed on a plurality of physical computing resources. The operation management server 10 and other devices may be accommodated in one physical or logical computer. All or a part of processing implemented by executing the programs may be performed by hardware (for example, a field-programmable gate array).

FIG. 3 is a flowchart showing an example of the warehouse work control. The warehouse work control is performed by executing the warehouse work control program 111 by the CPU 102 of the operation management server 10.

The warehouse work control program 111 is a process performed by the operation management server 10 periodically or by acquiring input information on data to the operation management server 10.

The warehouse work control program 111 first executes the work delay detection program 112 (step 1111), and determines whether hindersome (step 1112). In a case not determined as hindersome, the process is ended. In a case determined as hindersome, the group configuration change program 113 is executed (step 1113), and it is determined whether any robot 20 whose group is to be changed is present (step 1114).

In a case where no robot 20 whose group is to be changed is present, the process is ended. In a case determined that a robot 20 whose group is to be changed is present, the shift determination program 114 is executed (step 1115). Finally, the on-movement-path work determination program 115 is executed (step 1116), and the process is ended.

FIG. 4 is a flowchart showing an example of the work delay detection. The work delay detection is performed by executing the work delay detection program 112 by the CPU 102 of the operation management server 10.

In the work delay detection, first, work result information is acquired from the work result information DB 122 (step 1121). An intra-group work line indicating the flow with which the work is performed in the work group is calculated based on the acquired information (step 1122), and the intra-group work line information DB 123 is generated or updated.

Next, information is acquired from the worker information DB 126 (step 1123), and an operable intra-group work line is extracted based on position information and work states of workers, except for workers who cannot count as a worker of the intra-group work line (step 1124).

Then, an order still remaining as a work in orders assigned to a work group in the past is acquired from the buffer information DB 124, order information assigned to the work group currently or from now is acquired from the order information DB 125. A processing time of a work included in buffer information and the order information is estimated based on a work time of a past intra-group work line (step 1125).

Next, the estimated processing time is compared with a time until the work group receives an order next time (step 1126), determined as hindersome (Step 1127) or as not hindersome (Step 1128), and the processing is ended.

FIG. 5 is a flowchart showing an example of the group configuration change. The group configuration change is performed by executing the group configuration change program 113 by the CPU of the operation management server 10.

In the group configuration change program 113, first, information of the work result information DB 122 and the worker information DB 126 is acquired, and a worker corresponding to a work in which a delay occurs with respect to a standard work time is specified (step 1131).

Next, information of the group information DB 121, the intra-group line information DB 123, the buffer information DB 124, and the order information DB 125 is acquired, and a processing time of a buffer and an order is estimated for each work group (step 1132).

Next, in order to extract a work group having a margin, the processing time is compared with a predetermined threshold 1 (step 1133). In a case in which the processing time is larger than the threshold 1, the process is ended. In a case in which the processing time is smaller than the threshold 1, it is determined whether the number of workers in the work group specified as having a long work time in step 1131 is larger than a predetermined threshold 2 (step 1134).

In a case in which the number of workers in the work group is smaller than the threshold 2, the process is ended. In a case in which the number of workers in the work group is larger than the threshold 2, it is determined to assign workers to the delayed work group (step 1135), and the process is ended.

FIG. 6 is a flowchart showing an example of the shift determination. The shift determination is performed by executing the shift determination program 114 by the CPU of the operation management server 10.

In the shift determination program 114, first, the information of the group information DB 121 and the worker information DB 126 is acquired, a movement path to a group that is a movement destination from a current location or a work end location of the worker whose assignment is to be changed is calculated (step 1141), and work groups on the movement path is specified (step 1142).

Then, along the movement path, for each work group on the movement path, a worker who is in a standby state or a worker whose direction of a work completion location is within a range of a next on-path work group is specified (step 1143). Here, the direction of the work completion location means, for example, a traveling direction of the robot 20.

Next, a movement time of the worker of the work group whose assignment is to be changed is compared with a scheduled work completion time of the worker of the on-path work group and a movement time until reaching a next work group on the movement path (step 1144).

When the movement time of the robot 20 whose assignment is to be changed is small, the process is ended. When the movement time of the robot 20 whose assignment is to be changed is large, the robot 20 of the on-path work group is selected as a robot to be moved to the next on-path work group and the process is ended (step 1145).

FIG. 7 is a flowchart showing an example of the on-movement-path work determination. The on-movement-path work determination is performed by executing the on-movement-path work determination program 115 by the CPU of the operation management server 10.

In the on-movement-path work determination program 115, first, the information of the buffer information DB 124 and the order information DB 125 is acquired (step 1151).

Next, it is determined whether a work in the buffer and the order on the movement path of the robot 20 moving between the work groups is present (step 1152). When no work in the buffer and the order on the movement path of the robot 20 moving between the work groups is present, the processing is ended. When the work in the buffer and the order on the movement path of the robot 20 moving between the work groups is present, the work is assigned to the moving robot 20 as a work to be performed during the movement (step 1153), and the process is ended.

Accordingly, in the warehouse work control system according to Embodiment 1, the work groups each including a plurality of work subjects are assigned to the plurality of work regions in the warehouse respectively, and the work is executed for each work group.

The warehouse work control system includes a work delay detection unit (the work delay detection program 112) that detects a work delay of the robot 20 that is the work subject, a group configuration change unit (the group configuration change program 113) that changes a configuration of a work group when it is determined that the work delay is hindersome to execution of a work, a shift determination unit (the shift determination program 114) that, when it is determined that a work subject whose work group is to be changed is present, determines a shift of the work subject, and an on-movement-path work determination unit (the on-movement-path work determination program 115) that determines the work to be performed on a movement path by the work subject.

The work delay detection unit determines that the work delay is hindersome to the execution of the work based on a processing time of the work. The group configuration change unit specifies a delayed work group in which the work is delayed based on the processing time of the work. The shift determination unit obtains the movement path from the work group at a current location to the delayed work group that is a movement destination, and determines the shift of the work subject.

The shift determination unit determines the shift of the work subject based on a traveling direction of the work subject. When the work subject moves on the movement path, the on-movement-path work determination unit causes the work subject to move while selecting a work that can be executed on the movement path and executing the work.

Here, the work subject includes an information processing device capable of autonomously moving in the warehouse.

Examples of the work subject include a robot that performs a shelf transport work, a conveyor that transports a package, a picking robot that performs a picking work, and the like.

FIG. 8 shows a database structure of the group information DB 121 present in the memory 101 of the operation management server 10.

The group information DB 121 is a database that manages information related to the work group, and includes a work group identifier indicating an identifier of a work group, a type of a worker included in the work group, a worker ID identifying the worker, a place in charge indicating a work under charge of the worker, a standard work time indicating a time taken for the worker to work, a range indicating coordinate information of the work group in the warehouse, and a gateway indicating coordinates of the gateway in the work group.

Here, the worker may include, in addition to a robot or an operator such as a person, any member necessary for performing the work, such as a tool or a movement path used for a warehouse work. For example, the worker includes an operator, an AGV, a conveyor, a forklift, and a picking robot.

FIG. 9 shows a database structure of the work result information DB 122 existing in the memory 101 of the operation management server 10.

The work result information DB 122 includes a work ID that is an identifier of a handled work in the work group, attribute information indicating content of the work, a work type indicating a type of the warehouse work, a worker type indicating a type of the worker who has performed the work, a worker ID for uniquely specifying the worker, and a work time indicating a time taken for the worker to work. The attribute information represents, for example, a size of a package.

FIG. 10 shows a database structure of the intra-group line information DB 123 present in the memory 101 of the operation management server 10.

The intra-group line information DB 123 includes a group ID that is an identifier of a work group, a line ID that is an identifier of a line in which continuity of the worker was specified based on a result of the work performed in the work line, an attribute that indicates an attribute of the work performed by the line in which the continuity of the worker was specified, a worker ID that is an identifier of the worker who performed the work in the line in which the continuity of the worker was specified, and the standard work time that indicates a time of the work performed by the line in which the continuity of the worker was specified. The attribute represents, for example, a size of a package.

FIG. 11 shows a database structure of the buffer information DB 124 present in the memory 101 of the operation management server 10.

The buffer information DB 124 is a database indicating accumulated information of works before and after the work group or the work included in the work group, and includes a buffer name indicating a place where works are accumulated, a work type indicating a type of the work, an ID that is an identifier of the work, and a work parameter such as a delivery destination of a package. The work type is distinguished into large and medium according to, for example, a size of the handled package.

FIG. 12 shows a database structure of the order information DB 125 present in the memory 101 of the operation management server 10.

The order information DB 125 includes an order name that is a name of a work input to a work group, a work type that indicates a type of the work, an ID that is an identifier of the work, a work parameter such as a delivery destination of a package, and time information such as a shipment time of the package. The work type is distinguished into large and medium according to, for example, a size of the handled package.

FIG. 13 shows a database structure of the worker information DB 126 present in the memory 101 of the operation management server 10.

The worker information DB 126 includes a worker ID that is an identifier of a worker who performs a warehouse work, worker parameters that are a feature and a capability of the worker, a state that indicates a current work situation of the worker, a current position that indicates coordinate information of the worker in a warehouse, a work completion location that is coordinate information of a place where the work performed by the worker is completed, and a work end time that is a time at which the work performed by the worker is ended.

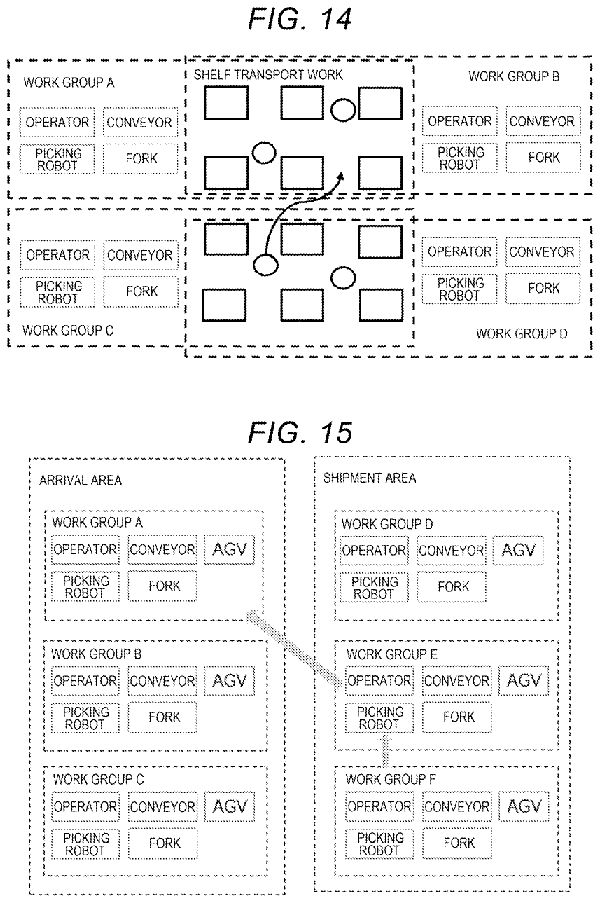

FIG. 14 is an example of movement between the work groups in the warehouse. Here, an example of movement of the robot 20 in a shelf transport work will be described. A series of works in the distribution warehouse include a wide range of works such as intake, inspection, receipt, storage, dispatch, sorting, loading, and a shelf transport work of transporting a shelf in the process. A work group is allocated to the series of works, and a person or the robot 20 in the work group performs the work.

In addition, it is also possible to share a part of works such as the shelf transport work between the work groups. In the example shown in FIG. 14, the shelf transport work is divided into a region shared by a work group A and a work group B, and a region shared by a work group C and a work group D. According to the warehouse work control system of the embodiment, for example, arrangement of the robots 20 can be changed from the region shared by the work group C and the work group D to the region shared by the work group A and the work group B.

FIG. 15 is an example of utilization of a system including the warehouse work control system. The warehouse works are divided into a plurality of groups A to F. According to the warehouse work control system of the embodiment, each of the robots 20 can move between the work groups.

However, it is considered that a plurality of work groups are present in the movement path between the work groups. Further, the worker cannot perform the work during the movement time in the warehouse, and thus the worker whose assignment is to be changed does not directly move between the work groups. Instead, if there is a worker having the same ability, movement of the worker is determined sequentially from a work group closest to the work group of the movement destination, and the assignment of the worker is changed in a billiard manner.

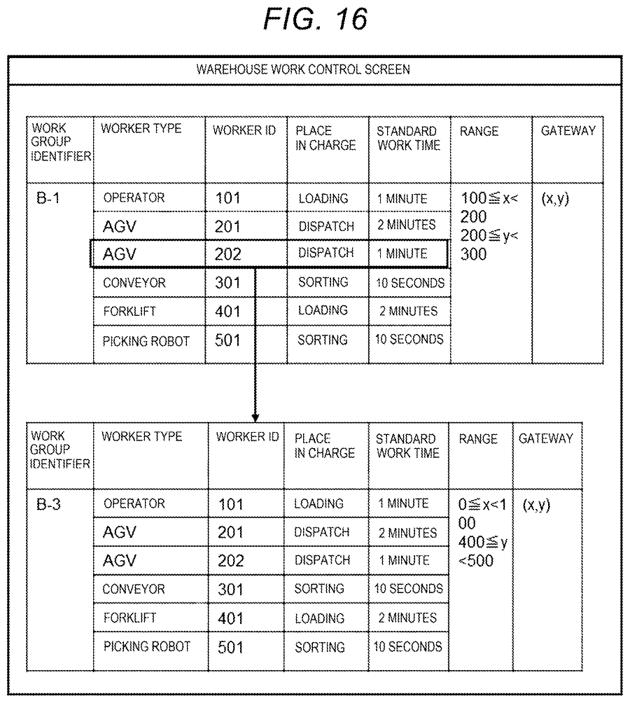

FIG. 16 is an example of a warehouse work control screen. The work situation of the work group and recommended movement of a worker between work groups (see an arrow shown in FIG. 16) are determined. Alternatively, a change history between the work groups of the worker is displayed.

The warehouse work control system according to the above embodiment is a warehouse work control system including a plurality of autonomously movable information processing devices that, in a warehouse having a plurality of work processes, each perform a work for each of the work processes.

The warehouse work control system according to the described embodiment includes: a processing time calculation unit configured to calculate a processing time of the work assigned to the work processes; a movement path calculation unit configured to calculate a movement path through which each of the information processing devices moves between the work processes; and a movement determination unit configured to determine, by using the processing time and the movement path, movement of the information processing device between the work processes based on an operation situation and a movement direction of the information processing device for each work process.

According to the above embodiment, when a plurality of series of work processes are present in the distribution warehouse, the arrangement of the robots is changed according to a load and a situation between the work processes. Accordingly, it is possible to eliminate a load on a portion serving as a bottleneck portion between the work processes and further improve an operation rate of the entire warehouse by determining a movement method between the work processes.

What is claimed is:

1. A warehouse work control system comprising:
a plurality of information processing devices configured to move autonomously and, in a warehouse having a plurality of work processes, each perform a work for each of the work processes;
a processing time calculation unit configured to calculate a processing time of the work assigned to the work processes;
a movement path calculation unit configured to calculate a movement path through which each of the information processing devices moves between the work processes; and
a movement determination unit configured to determine, by using the processing time and the movement path, movement of the information processing device between the work processes based on an operation situation and a movement direction of the information processing device for each work process.

2. The warehouse work control system according to claim 1, wherein
the movement determination unit determines the movement including the information processing device on the movement path when the information processing device moves across a plurality of the work processes.

3. The warehouse work control system according to claim 1, wherein
the movement determination unit determines the movement of the information processing device based on a current work situation and a current position of the information processing device.

4. The warehouse work control system according to claim 1, wherein
the movement determination unit determines the movement of the information processing device based on a traveling direction of the information processing device.

5. The warehouse work control system according to claim 1, wherein
when moving on the movement path, the information processing device moves while selecting a work that can be executed on the movement path and executing the work.

6. The warehouse work control system according to claim 1, wherein
a series of works are executed by a combination of the information processing devices when the work is executed for each work process.

7. A warehouse work control system in which work groups each including a plurality of work subjects are assigned to a plurality of work regions in a warehouse respectively and a work is executed for each work group, the warehouse work control system comprising:
a work delay detection unit configured to detect a work delay of each of the work subjects;
a group configuration change unit configured to change a configuration of the work group when it is determined that the work delay is hindersome to the execution of the work;
a shift determination unit configured to, when it is determined that a work subject whose work group is changed is present, determine a shift of the work subject; and
an on-movement-path work determination unit configured to determine the work to be performed on a movement path by the work subject.

8. The warehouse work control system according to claim 7, wherein
the work delay detection unit determines that the work delay is hindersome based on a processing time of the work.

9. The warehouse work control system according to claim 7, wherein
the group configuration change unit specifies a delayed work group in which the work is delayed based on the processing time of the work, and
the shift determination unit determines the shift of the work subject by obtaining the movement path from the work group at a current location to the delayed work group that is a movement destination.

10. The warehouse work control system according to claim 9, wherein
the shift determination unit determines the shift of the work subject based on a traveling direction of the work subject.

11. The warehouse work control system according to claim 9, wherein
when the work subject moves on the movement path, the on-movement-path work determination unit causes the work subject to move while selecting a work that can be executed on the movement path and executing the work.

12. The warehouse work control system according to claim 7, further comprising:
a display unit, wherein
the display unit displays
a work situation of the work group,
the movement of the work subject between the work groups, and
a change history of the work subject between the work groups.

13. The warehouse work control system according to claim 7, wherein
the work subject includes an information processing device configured to move autonomously in the warehouse.

14. A warehouse work control method for, in a warehouse having a plurality of work processes, performing a work for each of the work processes using a plurality of information processing devices configured to move autonomously, the warehouse work control method comprising:
calculating a processing time of the work assigned to the work processes;
calculating a movement path through which each of the information processing devices moves between the work processes; and
determining, by using the processing time and the movement path, movement of the information processing device between the work processes based on an operation situation and a movement direction of the information processing device for each work process.

15. The warehouse work control method according to claim 14, wherein
the movement of the information processing device is determined based on a traveling direction of the information processing device, and
when moving on the movement path, the information processing device moves while selecting a work that can be executed on the movement path and executing the work.
